(19) United States
(12) Patent Application Publication
(10) Pub. No.: US 2007/0014495 A1
(43) Pub. Date: Jan. 18, 2007

(54) System, method, and apparatus for reducing residual stress in as-welded roller cone bit ball plug welds

(75) Inventors: Anton F. Zahradnik, Sugar Land, TX (US); Eric C. Sullivan, Houston, TX (US); Don Q. Nguyen, Houston, TX (US); Gregory L. Ricks, Spring, TX (US); Christopher C. Beuershausen, Magnolia, TX (US); Ronnie L. Jones, New Waverly, TX (US)

Correspondence Address: BRACEWELL & GIULIANI LLP, P.O. Box 61389, HOUSTON, TX, 77208-1389, US

(73) Assignee: Baker Hughes Incorporated

(21) Appl. No.: 11/183,121

(22) Filed: Jul. 15, 2005

(51) Int. Cl. F16C 33/30

(52) U.S. Cl. 384/96

(57) ABSTRACT

A roller cone bit has a ball retention system to secure the cones to the head. A radial ball race includes a ball way with a ball plug to keep the balls in the ball race. The ball plug is secured to the head by welding. Any residual stress in the weld region is alleviated by one of several solutions. Material may be selectively removed from the weld, the heat-affected zone, and/or the surrounding area to promote relaxation of residual stress. Alternatively, deflection is imposed and/or heat or vibration is applied to promote relaxation.

### BACKGROUND OF THE INVENTION

1. Technical Field

The present invention relates in general to stress reduction in roller cone bits and, in particular, to an improved system, method, and apparatus for reducing residual stress in as-welded roller cone bit ball plug welds.

2. Description of the Related Art

Rotary-type drill bits include both rotary drag bits and roller-cone bits. In a roller-cone arrangement, the bit typically has three cones, each independently rotatable with respect to the bit body supporting the cones through bearing assemblies. The cones carry either integrally formed teeth or separately formed inserts that provide the cutting action of the bit.

Roller cone bits typically use a ball retention system for securing the cones to the heads. The retention system includes a radial ball race incorporated into each cone and the head bearings. A ball way is provided between the head ball race and the head outer diameter (OD) to facilitate assembly. When the cone is mated to the head, the respective ball races are aligned and, together, they define a toroidal space. Ball bearings are introduced via the ball way into the space. A ball plug is then inserted into the ball way to block the discontinuity (i.e., the hole) in the head ball race and to ensure that the ball bearings are retained in the race. The ball plug is secured to the head OD by welding.

While cooling from welding, residual stress can accumulate in the weld region (e.g., the fusion and heat-affected zones). Depending upon the orientation and magnitude of the residual stress, the service load capacity of the assembly can be significantly reduced. This structural configuration gives rise to one type of head section failure, which includes cracks that initiate at the root of the ball plug weld and then propagate toward the head OD, and then turn and propagate toward the base of the bearing pin. Solutions for addressing this problem would be desirable.

### SUMMARY OF THE INVENTION

One embodiment of a system, method, and apparatus of the present invention describes several solutions for reducing residual stress in the region of as-welded ball plug welds. In one embodiment, material is selectively removed from the weld, the heat-affected zone, and/or the surrounding area to promote relaxation of residual stress. In an alternate embodiment, deflection is imposed and/or heat or vibration is applied to promote relaxation. By reducing weld area residual stress with the present invention, service load capacity and/or service life is increased.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the invention, as well as others which will become apparent are attained and can be understood in more detail, more particular description of the invention briefly summarized above may be had by reference to the embodiment thereof which is illustrated in the appended drawings, which drawings form a part of this specification. It is to be noted, however, that the drawings illustrate only an embodiment of the invention and therefore are not to be considered limiting of its scope as the invention may admit to other equally effective embodiments.

FIG. 1 is a half-sectional view of one embodiment of a roller cone bit constructed in accordance with the present invention;

FIG. 2 is an enlarged sectional view of a head and cone portion of the roller cone bit of FIG. 1 and is constructed in accordance with the present invention;

FIG. 3 is an enlarged sectional view of another embodiment of a roller cone bit constructed in accordance with the present invention; and

FIG. 4 is a high level flow diagram of one embodiment of a method constructed in accordance with the present invention.

### DETAILED DESCRIPTION OF THE INVENTION

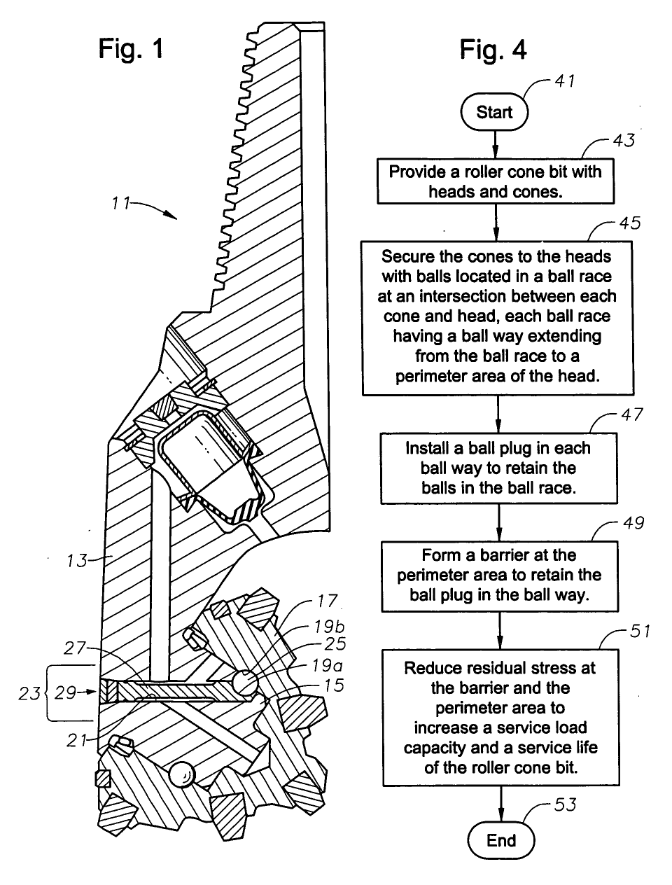

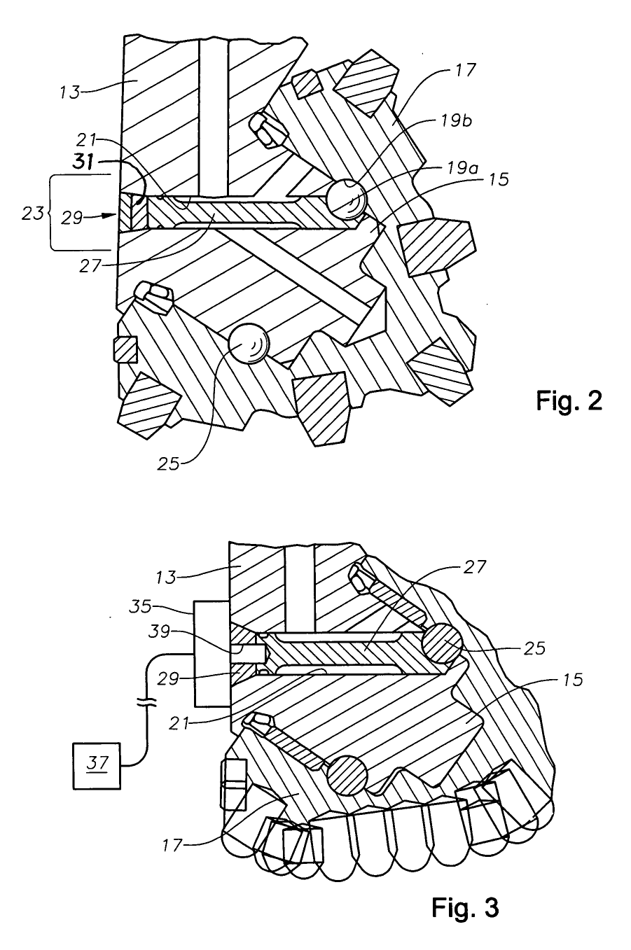

Referring to FIGS. 1 and 2, one embodiment of a roller cone bit 11 constructed in accordance with the present invention is shown. Bit 11 comprises a bit body 13 having heads 15 (one shown) with cones 17. Each head 15 and cone 17 includes a retention system having a ball race 19 at an intersection between the head 15 and cone 17. A ball way 21 extends from the ball race 19 to an outer diameter (left sides of FIGS. 1 and 2) of the head 15. The outer diameter forms a portion of a perimeter area 23 of the head 15. The perimeter area 23 generally includes a region of the head 15 extending from the ball way 21 radially outward and axially inward with respect to the ball way 21.

The respective ball races 19a, 19b of the head 15 and cone 17 are aligned to define a toroidal space. Balls 25 are located in the ball race 19 for mechanically retaining the cone 17 on the head 15. A ball plug 27 is located in the ball way 21 to retain the balls 25 in the ball race 19. A barrier 29, such as a weld, is formed adjacent the outer diameter of the head 15 to secure the ball plug 27 in the ball way 21.

The present invention also comprises stress reduction means for reducing residual stress at the barrier (e.g., weld) 29 and the perimeter area 23 of the head 15 adjacent the outer diameter to increase a service load capacity and a service life of the roller cone bit 11. In one embodiment, the stress reduction means comprises an inner weld 31 (FIG. 2) formed from a first material adjacent the ball plug 27. The weld 29 is formed on the inner weld 31 from a second material that has a higher strength than the first material. The first material may comprise many different materials, including nickel, nickel alloy, stainless steel, and inconel. The second material may comprise steel or the like.

In addition, a single weld having comprising one or more passes may be used as the barrier 29. These embodiments also may utilize a single material, such as nickel, to form the welds. Moreover, the entire weld may be formed from a single, softer material. In another embodiment of the present invention, the stress reduction means comprises a void 39 (FIG. 3) in the barrier 29. The void 39 may comprise a drilled hole that extends in an axial direction of the ball way 21.

The present invention also comprises a system for reducing residual stress in a roller cone bit 11. One embodiment of the system comprises the elements described above, including the retention system for securing the cones 17 to the heads 15. A residual stress reduction is located at the barrier 29 and the perimeter area 23 to increase a service load capacity and a service life of the roller cone bit 11. The residual stress reduction may comprise an inner weld 31 formed adjacent the ball plug 27 from a first material, and the barrier 29 may comprise an outer weld formed on the inner weld 31 from a second material that has a higher strength than the first material.

The residual stress reduction also may comprise a heat treatment that may be performed on the entire roller cone bit 11. As shown in FIG. 3, the residual stress reduction may be localized and limited to the barrier 29 and the perimeter area 23, as with a small device 35 (e.g., a heat source, an ultrasonic tool, etc.) and a controller 37 for applying a heat treatment or an ultrasonic vibration treatment, respectively, to the barrier 29 and the perimeter area 23. Also described above, the residual stress reduction may be accomplished by removing material from the barrier 29, such as by forming a hole 39 in the barrier 29 that extends in an axial direction with respect to the ball way 21.

The present invention also comprises a method of reducing residual stress in a roller cone bit. As shown in FIG. 4, one embodiment of the method starts as indicated at step 41, and comprises providing a roller cone bit with heads with cones (step 43); securing the cones to the heads with balls located in a ball race at an intersection between each cone and head, each ball race having a ball way extending from the ball race to a perimeter area of the head (step 45); installing a ball plug in each ball way to retain the balls in the ball race (step 47); forming a barrier at the perimeter area to retain the ball plug in the ball way (step 49); reducing residual stress at the barrier and the perimeter area to increase a service load capacity and a service life of the roller cone bit (step 51); before ending as indicated at step 53.

The method also may comprise forming an inner weld from a first material adjacent the ball plug, and forming an outer weld on the inner weld from a second material that has a higher strength than the first material. Step 51 may comprise applying a heat treatment, such as by subjecting the ball plug to elevated temperatures during the stress relief operation. This embodiment may further comprise localizing the heat treatment to a limited portion of the roller cone bit including the barrier and the perimeter area, or subjecting the entire roller cone bit to the heat treatment. Step 51 also may comprise applying an ultrasonic vibration treatment the barrier and the perimeter area, or removing material from the barrier, such as by forming a hole in the barrier that extends in an axial direction of the ball way.

While the invention has been shown or described in only some of its forms, it should be apparent to those skilled in the art that it is not so limited, but is susceptible to various changes without departing from the scope of the invention.

What is claimed is:

1. A method of reducing residual stress in a roller cone bit, the method comprising:
(a) providing a roller cone bit with heads with cones;
(b) securing the cones to the heads with balls located in a ball race at an intersection between each cone and head, each ball race having a ball way extending from the ball race to a perimeter area of the head;
(c) installing a ball plug in each ball way to retain the balls in the ball race;
(d) forming a barrier at the perimeter area to retain the ball plug in the ball way; and
(e) reducing residual stress in the barrier and the perimeter area to increase a service load capacity and a service life of the roller cone bit.

2. A method according to claim 1, wherein step (e) comprises forming an inner weld from a first material adjacent the ball plug, and forming an outer weld on the inner weld from a second material that has a higher strength than the first material.

3. A method according to claim 2, wherein the first material is selected from the group consisting of nickel, nickel alloy, stainless steel, and inconel, and the second material is steel.

4. A method according to claim 1, wherein step (e) comprises applying a stress relief operation with heat treatment.

5. A method according to claim 4, further comprising subjecting the ball plug to elevated temperatures during the stress relief operation.

6. A method according to claim 4, further comprising localizing the heat treatment to a limited portion of the roller cone bit including the barrier and the perimeter area.

7. A method according to claim 4, further comprising subjecting the entire roller cone bit to the heat treatment.

8. A method according to claim 1, wherein step (e) comprises applying an ultrasonic vibration treatment to the barrier and the perimeter area.

9. A method according to claim 1, wherein step (e) comprises removing material from the barrier.

10. A method according to claim 9, further comprising forming a hole in the barrier that extends in an axial direction of the ball way.

11. A method according to claim 1, wherein step (e) comprises forming a single weld from a material selected from the group consisting of nickel, nickel alloy, stainless steel, and inconel.

12. A method according to claim 11, further comprising forming the single weld with at least one pass from a single material.

13. A system for reducing residual stress in a roller cone bit, comprising:
a bit body having heads with cones;
a retention system for securing the cones to the heads, including a ball race at an intersection between each cone and head, a ball way extending from the ball race to a perimeter area of the head, balls in the ball race for mechanically retaining the cone on the head, a ball plug located in the ball way to retain the balls in the ball race, and a barrier formed at the perimeter area to secure the ball plug in the ball way; and
a residual stress reduction in the barrier and the perimeter area to increase a service load capacity and a service life of the roller cone bit.

14. A system according to claim 13, wherein the residual stress reduction comprises an inner weld formed adjacent the ball plug from a first material, and the barrier comprises an outer weld formed on the inner weld from a second material that has a higher strength than the first material.

15. A system according to claim 14, wherein the first material is selected from the group consisting of nickel, nickel alloy, stainless steel, and inconel, and the second material is steel.

16. A system according to claim 13, wherein the residual stress reduction comprises a stress relief of heat treatment.

17. A system according to claim 16, wherein the ball plug is subjected to elevated temperatures during the heat treatment.

18. A system according to claim 16, wherein the heat treatment is localized and limited to the barrier and the perimeter area.

19. A system according to claim 16, wherein the heat treatment is performed on the entire roller cone bit.

20. A system according to claim 13, wherein the residual stress reduction comprises an ultrasonic vibration treatment of the barrier and the perimeter area.

21. A system according to claim 13, wherein the residual stress reduction comprises material removed from the barrier.

22. A system according to claim 21, wherein the material is removed from the barrier by forming a hole in the barrier that extends in an axial direction with respect to the ball way.

23. A system according to claim 13, wherein the barrier is a single weld formed from a material selected from the group consisting of nickel, nickel alloy, stainless steel, and inconel.

24. A system according to claim 23, wherein the single weld is formed with at least one pass from a single material.

25. A roller cone bit, comprising:
a bit body having heads with cones, each head and cone including a ball race at an intersection between the head and cone, a ball way extending from the ball race to an outer diameter of the head, the respective ball races of the head and cone being aligned to define a toroidal space, balls located in the ball race for mechanically retaining the cone on the head, a ball plug located in the ball way to retain the balls in the ball race, and a weld formed adjacent the outer diameter of the head to secure the ball plug in the ball way; and
stress reduction means for reducing residual stress in the weld and a perimeter area of the head adjacent the outer diameter to increase a service load capacity and a service life of the roller cone bit.

26. A roller cone bit according to claim 25, wherein the stress reduction means comprises an inner weld formed from a first material adjacent the ball plug, and the weld is formed on the inner weld from a second material that has a higher strength than the first material.

27. A roller cone bit according to claim 26, wherein the first material is selected from the group consisting of nickel, nickel alloy, stainless steel, and inconel, and the second material is steel.

28. A roller cone bit according to claim 25, wherein the stress reduction means comprises a void in the barrier.

29. A roller cone bit according to claim 28, wherein the void in the barrier is a hole that extends in an axial direction of the ball way.
